(19) United States
(12) Patent Application Publication
(10) Pub. No.: US 2006/0058057 A1
(43) Pub. Date: Mar. 16, 2006

(54) High capacity ancillary storage unit removably attachable to mobile cellular telephone member

(75) Inventors: Lane Thomas Holloway, Pflugerville, TX (US); Walid M. Kobrosly, Round Rock, TX (US); Nadeem Malik, Austin, TX (US); Marques Benjamin Quiller, Pflugerville, TX (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 10/943,049

(22) Filed: Sep. 16, 2004

(51) Int. Cl. H04Q 7/20

(52) U.S. Cl. 455/550.1

(57) ABSTRACT

Cellular telephones embodying 3G system protocols with a storage drive that can add upwards of two to four gigabytes of data storage to the mobile wireless cellular telephone member in a portable attachment that is readily integratable with any standard cellular 3G telephone housing. A high function Third Generation (3G) cellular telephone with high functions, such as teleconferencing and multimedia, is enhanced with a high capacity ancillary storage unit removably attached to the telephone that includes a housing having means for receiving the ancillary storage unit. The ancillary storage unit preferably has a USB I/O slot for removably receiving a USB key drive.

### TECHNICAL FIELD

The present invention relates to telecommunications systems and particularly to mobile wireless cellular telephone systems.

### BACKGROUND OF RELATED ART

With the globalization of business, industry and trade wherein transactions and activities within these fields have been changing from localized organizations to diverse transactions over the face of the world, the telecommunication industries have been expanding rapidly. Wireless telephones and, particularly, cellular telephones have become so pervasive that their world wide number is in the order of hundreds of millions.

Because of the widespread use of cellular telephones, particularly in business and trade, the functions demanded of the standard cellular handheld telephones have been rapidly increasing. In this connection, in order to better understand the dynamics of these changes, a review of telecommunication should be helpful. The standard wired telecommunications system, which has been in use world wide for well over 120 years, is the conventional handheld or speaker input wired into a base that in turn is wired into a Public Switched Telephone Network (PSTN) with wired switched channel paths to and from other telephones or like devices through their bases. These telephones are respectively connected to the PSTN via local switching centers or switching nodes in a fully wired telecommunication system. Conventionally, these switching centers have many telephones connected to each. The centers operate to control the channel connections, i.e. switch into and out of the PSTN, those calls originated or terminated at telephone stations.

In addition, there have been developed, over the past 20 years, two major mobile wireless systems: 1) the short range wireless radio frequency (RF) “cordless” telephone system; and 2) the mobile wireless long range RF “wireless” telephone system that has been commercialized primarily as the “cellular” telephone system.

Before the cellular wireless phone system was developed, long range mobile wireless phones were relatively rudimentary; they were usually in automobiles. There was usually one central tower with about 25 channels available on the tower. The mobile wireless telephone needed a large powerful transmitter, usually in the automobile that had to transmit up to 50 miles. This was too cumbersome for any personal or portable phone. In the cellular system for the handheld mobile wireless phone, an area such as a city is broken up into small area cells. Each cell is about 10 square miles in area. Each has its base station that has a tower for receiving/transmitting and a base connected into PSTN. Even though a typical carrier is allotted about 800 frequency channels, the creation of the cells permit extensive frequency reuse so that tens of thousands of people in the city can be using their cell phones simultaneously. Cell phone systems are now preferably digital with each cell having over 160 available channels for assignment to users. In a large city there may be hundreds of cells, each with its tower and base station. Because of the number of towers and users per carrier, each carrier has a Mobile Telephone Switching Office (MTSO) that controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two-way long range RF communication. In the United States, cell phones are assigned frequencies in the 824-894 MHz ranges. Since transmissions between the cell telephone and cell tower are digital, but the speaker and microphone in the telephone are analog, the cell telephone has to have a D to A converter from the input to the phone speaker, and an A to D converter from the microphone to the output to the cell tower. Cellular arrays offer a very effective means of wireless communication within their array areas in the order of 10 square miles each. The cellular telephone systems described above are second generation (2G) systems. Over the past two or three years, the industry has been undergoing a transition from these second generation systems to third generation (3G) systems, the standards and protocols of which have been defined by the International Telecommunications Union (ITU). One of the ITU's protocols involves Global Roaming, i.e. any 3G cellular telephone should be able to communicate with any other 3G cellular telephone any where in the world. 3G protocols require a minimum transmission rate of 144 Kbits/s from a speeding vehicle, 384 Kbits/s from a walking pedestrian and 2 Mbits/s from a stationary position. With the achievement of such high data transmission rates, many cellular phone functions become possible, such as navigation, geographic tracking, location services and various multimedia functions. The cellular phone systems are required to handle the new MPEG-4 data compression functions. As a result, two-way video conferencing between multiple parties on cellular telephones is now practical with this MPEG-4 function. This has led to increased teleconferencing involving multiple cellular telephones. In addition, with the increased multimedia function becoming available on cellular telephones, the conventional cellular telephone memory of up to 8 megabytes has been insufficient to cover the memory and storage needs of conventional cellular telephone users of systems with this third generation technology (3G).

### SUMMARY OF THE PRESENT INVENTION

The present invention provides cellular telephones embodying 3G system protocols with a storage drive that can add upwards of two to four gigabytes of data storage to the mobile wireless cellular telephone member in a portable attachment readily integratable with any standard cellular 3G telephone housing.

Accordingly, the present invention provides a mobile cellular telephone member comprising wireless RF means for communicating with a station in a cell of a cellular telephone system, a display for displaying data received from the cellular system, a data processing unit for controlling the operational functions of the cellular telephone member and the standard limited capacity telephone memory for storing said operational functions, but further including a high capacity ancillary storage unit removably attached to said telephone member. The mobile cellular telephone member preferably includes a housing having means for receiving the ancillary storage unit. This ancillary storage unit is preferably a programmable memory card, such as a flash memory card, e.g. a memory stick. The housing may include a USB I/O slot functioning as the means for receiving a removable memory card inserted into said USB I/O slot. Best results in accordance with the invention are found when the memory card is a USB Key Drive connected into the USB I/O slot.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of a cellular telecommunications network set up to practice video conferencing using cellular telephones in accordance with this invention. Communication to and from cell phones is through towers connected to base stations in turn connected to an interconnection Public Switched Transmission Network (PSTN);

FIG. 2 is a generalized block view of a conventional wireless cellular telephone member illustrating how such a member can be set up to receive the ancillary memory in accordance with the present invention; and

FIG. 3 is side view of the illustrative telephone member of FIG. 2.

### DETAILED DESCRIPTION OF THE PREFERRED EMBODIMENT

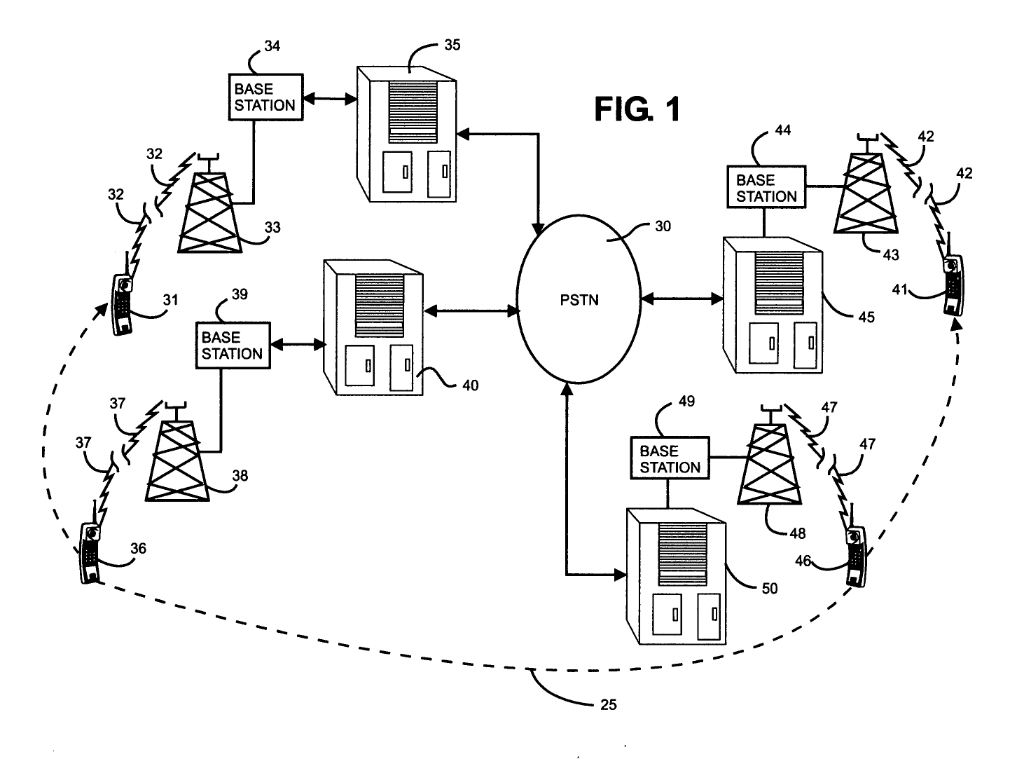

Referring to FIG. 1, a cellular telecommunications network is shown set up to have video conference using 3G cellular telephones. A portion of a PSTN 30 is shown with appropriate channel paths to and from mobile wireless channels and cellular telephones. These cellular telephones are connected to the PSTN 30 via local switching centers or switching nodes 35, 40, 45 and 50 in a fully wired telecommunications system. Conventionally, these switching nodes have many telephones connected to each. The centers operate to control the channel connections, i.e. switching into and out of the PSTN 30 those calls originated or terminated at telephones. Thus, mobile cellular telephones 31, 36, 41 and 46 are linked into the PSTN 30. There are cellular telephone communication paths from the respective cellular phone antennae to antennae on towers 33, 38, 43 and 48. The distribution or routing of the telecommunications from to, from and within the PSTN 30 is quite similar to the routing of conventional wired telephone calls. Similarly, in the RF communication via cellular towers 33, 38, 43 or 48, the signals are passed through base stations 34, 39, 44 and 49, the telephone calls pass through the respective base stations and then through the switching centers for the calls to PSTN 30. With such a conventional arrangement, the cellular telephones are shown interconnected into a teleconference involving two-way video between the respective phones as illustrated by dashed line 25 linking cellular telephones 31, 36, 41 and 46 into an active telephone conference.

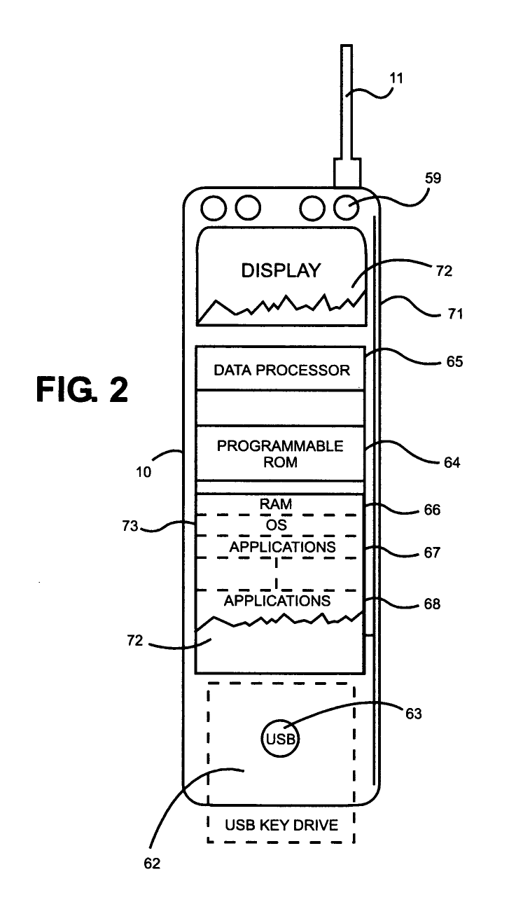

Now with respect to FIG. 2, an illustrative cellular telephone member structure with attached ancillary high capacity storage unit will be described. However, before proceeding further with this description, we will, at this point, provide some background with respect to the 3G cellular telephones used in the present invention. It should be understood that the ancillary storage drives of the present invention do not require such 3G cellular telephones. The ancillary storage drives may be used in connection with lower function cellular telephones. However, it is the high function of 3G cellular telephones that gives rise to the need for additional high capacity storage. Consequently, it is outside of the scope of the present invention to detail the high function required of 3G cellular telephones. It is sufficient to note that the ITU has a published standard for 3G that is reviewed in detail (for example) in an Electronic Design article published in 2004, entitled Designers Face Tough Challenges to 3G Cellular/PCS Phone Specs available from the Web at www.electronic design.com/Articles/Print.cmf?ArticleD=4786.

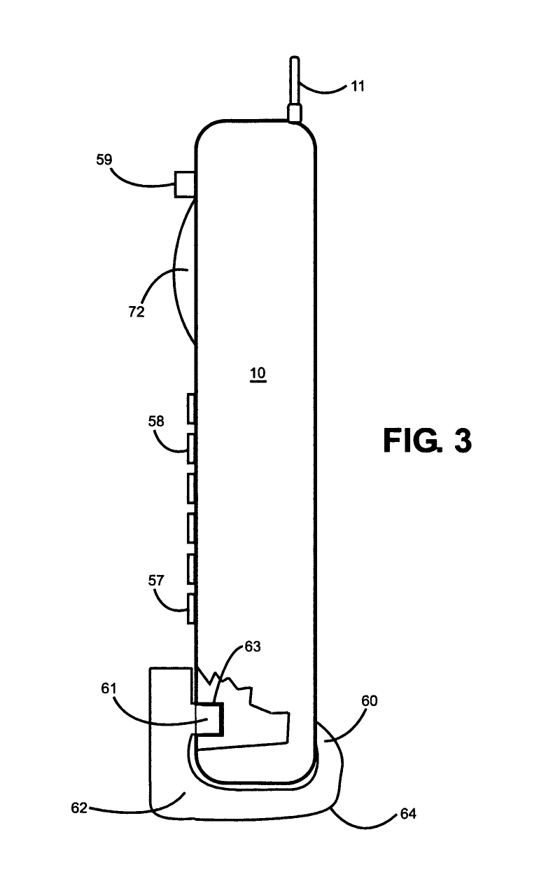

The generalized cell telephone shown in FIG. 3 includes a data processor, operating system, about 2 to 4 MB of RAM and a permanent programmable memory, a programmable ROM that may be an EPROM or flash ROM. Because these flash ROMs can now provide 4 MB of capacity, all of the application programs and routines are conventionally stored on the telephone's RAM and may also be stored in this ROM. In addition, the telephone operating system and built-in applications are also conventionally stored in the ROM. Thus, the cellular telephone 10 includes a data processor 65, a programmable ROM 64, a RAM 66 that is shown in an operational state loaded with the telephone's operating system 73 and its application programs 67, including routines required to practice the present invention. The telephone 10 also includes antenna 11, control buttons 59 and display screen 72. An ancillary programmable memory drive 62 is then attached to the cellular telephone housing 10. Preferably, this ancillary memory is embodied in a detachable USB key drive. However, other types of ancillary programmable memory drives may also be used. These relatively high capacity (up to 4 gigabytes) memory drives can provide a substantial amount of supplementary or ancillary storage required for support of 3G cellular telephone increased function. As set forth above, the memory cards may be a programmable memory card, such as a flash memory card or a memory stick popular with digital cameras. Very good results are achieved when the housing includes a USB I/O slot and the removable memory card is inserted into said USB I/O slot. The USB key drive is particularly effective for this purpose. A better view of how a USB key drive may be attached and integrated into the cellular telephone is shown in FIG. 3, which is a diagrammatic side view of the telephone of FIG. 2. The key drive 62 has a male contact member removably receivable by USB slot 63. The casing 64 of key drive 62 may be made of a suitable flexible resilient plastic material so as to have a wrap around flange 60 that engages the back of the telephone housing to detachably seat USB key drive at the lower end of the telephone so that the key drive becomes an unobtrusive part of the telephone body. The key pad buttons 57 and 58 of the telephone are shown for orientation.

It should be noted that for purposes of illustrating the present invention, details about the audio and video portions of the 3G cellular telephone have been omitted. These are not specific for the present invention and are well described in the above-referenced literature on cellular telephones and particularly 3G cellular technology.

The USB key drive 62 is connected via a standard system bus under the control of the telephone processor 65 to RAM 66 and ROM 64 in order to conventionally interchange this high capacity storage with system memory. This addition of the key drive will extend the 4 to 8 Megabyte telephone memory with from 1 to 3 Gigabytes of ancillary storage. USB key drives are well documented in the art. For a general description of such structures, reference is made to the on-line Wikipedia Foundation free encyclopedia at en.wikipedia.org/wiki/Keydrive.

Although certain preferred embodiments have been shown and described, it will be understood that many changes and modifications may be made therein without departing from the scope and intent of the appended claims.

What is claimed is:

1. A mobile cellular telephone member comprising:
wireless RF means for communicating with a station in a cell of a cellular telephone system;
a display for displaying data received from the cellular system;
a data processing unit for controlling the operational functions of the cellular telephone member;
a limited capacity telephone memory for storing said operational functions; and
a high capacity ancillary storage unit removably attached to said telephone member.

2. The mobile cellular telephone member of claim 1 further including a member housing having means for receiving said ancillary storage unit.

3. The mobile cellular telephone member of claim 2 wherein said removably attached storage unit is a programmable memory card.

4. The mobile cellular telephone member of claim 3 wherein said programmable memory card is a flash memory card.

5. The mobile cellular telephone member of claim 4 wherein said housing includes a USB I/O slot and said removable memory card is inserted into said USB I/O slot.

6. The mobile cellular telephone member of claim 2 wherein said cellular telephone member is a Third Generation (3G) standard cellular telephone.

7. The mobile cellular telephone member of claim 6 wherein said removably attached storage unit is a programmable memory card.

8. The mobile cellular telephone member of claim 7 wherein said programmable memory card is a flash memory card.

9. The mobile cellular telephone member of claim 8 wherein said flash memory card is a memory stick.

10. The mobile cellular telephone member of claim 7 wherein said housing includes a USB I/O slot and said removable memory card is inserted into said USB I/O slot.

11. The mobile cellular telephone member of claim 10 wherein said memory card is a USB key drive.

12. The mobile cellular telephone member of claim 7 further including a two-way video implementation between the telephone member and at least one other cellular telephone.

13. The mobile cellular telephone member of claim 12 further including:
means for recording two-way video telephone calls between the mobile cellular member and said at least one other cellular telephone; and
means for storing said recorded two-way video telephone calls on said removable programmable memory card.

14. In a wireless cellular telephone system including an array of cellular areas, each including a base station:
a plurality of mobile wireless cellular telephone members, each member comprising:
wireless RF means for communicating with a base station;
a display for displaying data received from the cellular system;
a data processing unit for controlling the operational functions of the cellular telephone member;
a limited capacity telephone memory for storing said operational functions; and
a high capacity ancillary storage unit removably attached to said telephone member; and
means enabling said plurality of mobile wireless cellular telephones to wirelessly communicate with each other via said base stations using Third Generation (3G) standard cellular telephone communication protocols.

15. The wireless cellular telephone system of claim 14 further including a two-way video implementation between one of said cellular telephone members and at least one other cellular telephone member.

16. The wireless cellular telephone system of claim 15 further including:
means for recording two-way video telephone calls between one of the mobile cellular members and said at least one other cellular telephone member; and
means for storing the recorded two-way video telephone calls on said removable programmable memory card.

17. The wireless cellular telephone system of claim 16 wherein said means for recording said two-way telephone calls enable the recording of a video teleconference between a plurality of said cellular telephone members, whereby said means for storing, store said video teleconference on said removable programmable memory card.

18. The wireless cellular telephone system of claim 16 wherein said memory card is a USB key drive.
